(19) United States
(12) Patent Application Publication
(10) Pub. No.: US 2020/0128803 A1
(43) Pub. Date: Apr. 30, 2020

(54) Quick Set Fish Hook and Rig

(71) Applicant: Cyrus Nahvi, Carmel, IN (US)

(72) Inventor: Cyrus Nahvi, Carmel, IN (US)

(21) Appl. No.: 15/453,927

(22) Filed: Oct. 29, 2018

(51) Int. Cl. A01K 83/06

(52) U.S. Cl. CPC A01K 83/06; A01K 91/04

(57) ABSTRACT

The present invention includes a fishing rig and fish hook for live bait. The fish hook comprises a main body extending in a plane and defining a longitudinal axis, a first end, a second end, a top side and a bottom side. A plurality of hook portions extend from the body. The body further comprises an eyelet for attaching a fishing line. At least two shanks anchor the fish hook to the bait fish, one of the shanks extends from the first end at least partially along the longitudinal axis and the other shank extending from the second end at least partially along the longitudinal axis. The at least two shanks each have at least one barb extending from the shank for anchoring the fish hook to the live bait, wherein the barbs are adapted to prevent rotation of the body about the longitudinal axis relative to the live bait.

The present invention relates to hooks for fishing and, particularly, a quick set fishing rig and fish hook for live bait having a plurality of shanks for anchoring the fish hook in the body of the live bait.

### BACKGROUND OF THE INVENTION

Generally, fishing hooks comprise “J”-shaped pieces of metal having an eyelet at the top of the “J” for attaching a fishing line, and a barb at the opposite end of the “J.” Single hooks represent a con on type of fishing hooks. Multiple hooks are also known, such as the treble hook. While both types of hooks are found on artificial lures, typically, only a single hook is used for live bait.

When fishing with live bait for large game fish such as musky, attaching more than one hook to the live bait provides advantages for catching the game fish. It has been known to attach a single hook through the mouth of the live bait and a treble hook at approximately the mid-section of the bait. To do so, an additional line segment with a treble hook attached runs from the single hook in the mouth of the bait fish back along the bait fish to a desired location. One of the barbs of the treble hook is embedded into the bait, leaving the other two barbs exposed to hook a fish. That practice eliminates one of the three hooks from being available to hook the game fish.

U.S. Pat. No. 6,282,831 teaches one solution using a single shank to secure a treble hook to the bait fish. However, that solution has drawbacks that the present invention resolves. While such a rig provides the desired additional hooks for live bait, it has disadvantages. One major problem with known rigs is encountered when a fisherman or woman attempts to set the hook into the game fish striking the bait. To set a hook, a fisherman must provide a quick, strong jerk to the bait in an attempt to cause the exposed hooks to embed into the mouth of the game fish. However, as the fisherman or woman jerks the prior art rig, the barb of the treble hook which is attached to the bait tends to embed deeper into the bait. As a result, the force of the jerk to transferred to the bait, and the exposed barbs of the treble hook often do not embed into the game fish. The resultant jerk can also pull the bait and the hooks from the mouth of the striking fish. The game fish is not hooked, and the live bait is injured or killed. Then, the user must rig new live bait losing game fish, bait, time and money. In general, any hesitation or hindrance in the movement of the hooks when setting the hooks, could result in failing to hook the game fish.

A device is needed for rigging a live bait with multiple shanks to secure the hook to the live bait and with extra hooks to increase the probability for quickly and successfully hooking a striking game fish while reducing the loss of bait, time and money.

### BRIEF SUMMARY OF THE INVENTION

The present invention solves the above identified problems associated with prior art rigs and methods of rigging live bait with extra hooks. The hook of the present invention includes a body, at least two hooks, and at least two shanks for more securely anchoring the body to the bait fish. The shanks extend from either end of the body,. The shanks may be linear or nonlinear. The shanks may have at least one barb to enhance connection of the hook to the bait fish. The shanks are inserted under the skin of the bait fish to secure both ends of the body to the live bait while maximizing the hooks available to secure the game fish. The barbs of the shanks secure the shanks to the bait fish and reduce the probability of the hook from rotating about the shank axis or from disconnecting from the bait fish.

The disclosed invention provides easier penetration and anchoring of the hook to the bait fish in that it anchors in more than 1 location. A single shank design can release from the bait fish if the bait fish runs into weeds or other objects, whereas the multi-shank design disclosed herein provides improved anchoring of the rig to the bait fish. Because the generally linear shanks of the disclosed invention cause less damage to the bait fish, they provide longer bait fish life thereby saving time and money. The straight shanks are easier to unhook from the bait fish than regular hook designs. Regular designs bury into the baitfish, making them difficult to remove and most likely to kill the bait fish.

The hooks offset to lie along the side of bait fish at about 180° from each other relative to the body, which allows the rig to lie flat against the bait fish. Conversely, the known prior art hooks bend at angles that tend to drive the hooks into the bait fish instead of into game fish. Straight shanks do not bury into the baitfish like regular curved J hook anchoring designs. With the straight shanks, all the, hook setting power drives into the game fish, not the bait fish.

The known prior art does not provide 3 treble hooks for hook setting performance. Using one of the J hooks to attach to the bait fish leaves 2 J hooks for setting the game fish. The disclosed invention provides 3 J hooks for setting the game fish. The disclosed invention is not as bulky as prior designs and provides less distraction for the game fish, which in turn increases the success of game fishing.

The hook of the present invention can be used for any game fish, including, but not limited to, Musky, Northern Pike, Bass, Catfish, Marlin, Sailfish and the like.

The benefits of the live bait rig as disclosed and claimed, include a fluorocarbon leader having reduced visibility in the water and ore flexibility; an adjustable front hook whereas the prior art has a fixed front hook that provides too much torque on the treble hook; the swivel provides for easy connection with no tying required. The rig can be single, double or triple. The single front hook eliminates additional elements such as rubber bands, massive hooks or other products that impair the liveliness of the bait to provide longer life of bait fish.

The hook of the present invention may be used with an adjustable rig that allows the length between the mouth-hook and the body to be adjusted for use with bait fish varying in size.

It is an object of the present invention to provide a device for rigging live bait with extra hooks. It is another object of the present invention to provide a fishing hook having shanks for securing the hook to live bait. It is another object of the present invention to provide a fishing hook having shanks with barbs. It is also an, object of the invention to provide an adjustable rig for attaching a supplemental hook to live bait. It is an additional object of the present invention to provide a quick set fishing rig and fish hook.

Numerous other advantages and features of the invention will become apparent from the detailed description of the preferred embodiment of the invention, the claims, and the accompanying drawings.

### BRIEF DESCRIPTION OF THE DRAWINGS

FIG. 1 is a perspective view of one embodiment of the fishing hook of the present invention.

FIG. 2 is a top view of one embodiment of the fishing hook.

FIG. 3 is a side view of one embodiment of the fishing hook.

FIG. 4 is a front view of one embodiment of the fishing hook.

FIG. 5 is a back view of one embodiment of the fishing hook.

FIG. 6 is a view of an embodiment of the fishing hook with the rig attached.

FIG. 7 is a perspective view of an embodiment of the rig attached to a bait fish.

FIG. 8 is a perspective view of another embodiment of the fishing hook with a bent shank.

FIG. 9 is a perspective view of the rig of FIG. 7.

FIG. 10 is a perspective view showing the radial arc extending 180° around the bottom side.

FIG. 11 is a front view showing radial arcs extending about 90° between the hooks.

FIG. 12 is another embodiment of the rig of FIG. 9 comprising two hooks for attachment to both sides of the bait fish.

### DETAILED DESCRIPTION OF A PREFERRED EMBODIMENT OF THE INVENTION

While the invention has several embodiments in different forms, the drawings and the following description describes preferred embodiments. The present disclosure provides an exemplification of the principles of the invention but does not limit the spirit or scope of the invention or claims of the embodiment illustrated. One skilled in the art will appreciate that variations in dimensions, number of hooks, size of the barbs and lengths of the shanks can exist without departing from the scope of the claimed invention.

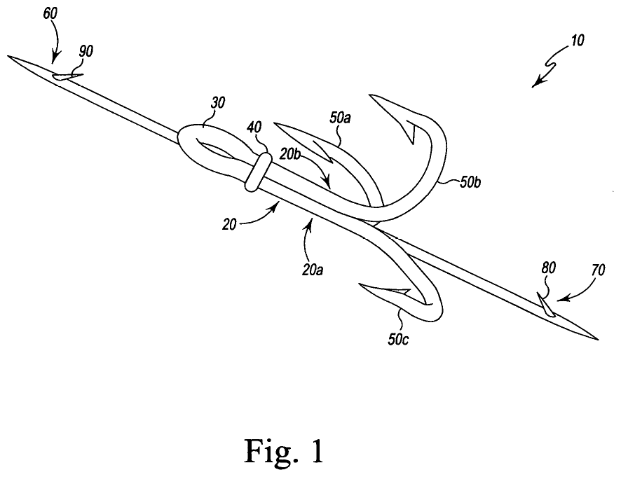

FIGS. 1 through 6 illustrate a preferred embodiment the fish hook 10 of the present invention. Hook 10 comprises a body 20 defining a longitudinal axis A (not shown), a bottom side 20a, and a tope side 20b, an eyelet 30 at the first end 40 of the body 20, at least two hooks 50a, 50b, 50c extending from the body 20, and first and second shanks 60, 70 extending from the body 20. The shanks 60, 70 may individually or collectively extend generally along axis A. One or both shanks 60, 70 may also extend at angles from the body that differ from axis A. Barbs 80, 90 can be positioned on the shanks 60, 70 to aid in securing the hook 10 to a bait fish.

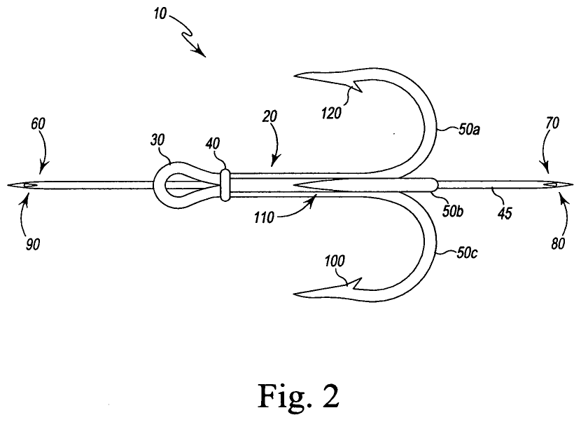

FIG. 2 is a top view of hook 10. The barbs 80, 90 may extend from the shanks 70, 60 in any desired direction, such as the bottom side 20a or the top side 20b. The hooks 50a, 50b and 50c may have barbs 100, 110,120. The barbs 80, 90 may be positioned around the shanks 60, 70 at any desired location.

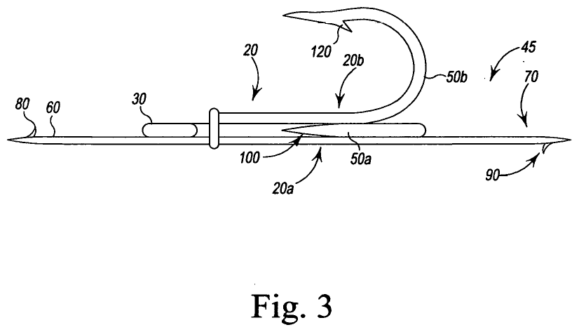

FIG. 3 is a side view of hook 10 showing non-linear shanks 60, 70. One of the hooks 50c is hidden by the body 20. The eyelet 30 may be positioned at a first end 40 of the body. The eyelet 30 secures a fishing line (not shown) to the body 20. The body has a second end 45, and the eyelet 30 may alternatively be positioned at the second end 45. In other embodiments, the eyelet 30 can be positioned anywhere along the body 20 between the first end 40 and the second end 45.

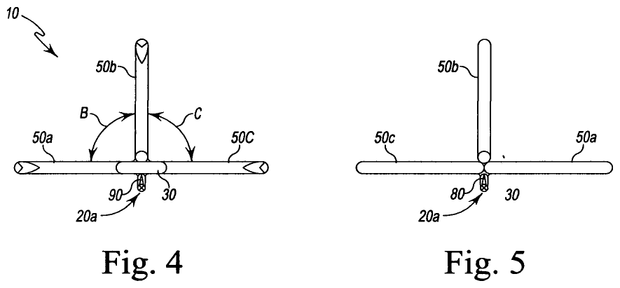

FIG. 4 is a front view of hook 10 from the second end 45. In one embodiment, the are B between hooks 50a and 50b is about 90 degrees and the are C between hooks 50b and 50c is about 90 degrees. The radial arc between the hooks 50a, 50b, 50c may be varied without departing from the scope of the invention. Likewise, the number of hooks 50a, 50b, 50c may be 2 or more without departing from the scope of the invention. One skilled in the art will appreciate that as the number of hooks 50 increases, the radial arc between the hooks will decrease. The radial arcs may be substantially the same or dissimilar. In a preferred embodiment, the hooks 50a, 50b and 50c do not extend substantially below the bottom side 20a. The hooks 50a, 50b and 50c and the shanks 60, 70 meet and form the body 20.

FIG. 5 is a rear view of the hook 10 from the first end 40. The eyelet 30 extends from the body 30 to accept a fishing line (not shown) to secure the hook 20 to a fishing rod (not shown). In one embodiment, the, shank 60 may be curved to provide easier access to the eyelet 30 for the user to secure a fishing line to the eyelet 30. In other embodiments, the shanks 60, 70 are substantially linear with respect to the body 20. In other embodiments, the shanks 60, 70 are non-linear with respect to the body 20 and axis A. In another embodiment, shank 60 is non-linear and shank 70 is substantially linear with respect to the body 20 and axis A.

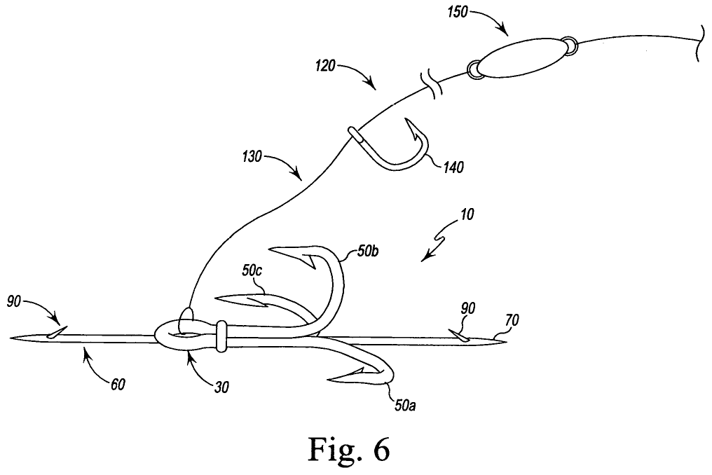

FIG. 6 shows the hook 10 with a rig 120 attached. The rig 120 comprises a fishing line 130 secured to eyelet 30. A mouth-hook 140 is movably secured to the line 130 to allow the mouth-hook 140 to be inserted into the mouth of the bait fish regardless of the size of the bait fish. A weight 150 is secured to the line 130 so that the mouth-hook 140 can slide between the eyelet 30 and the weight 150. The shanks 60, 70 are inserted into the bait fish so that the bottom side 20a is adjacent the bait fish and the hooks 50a, 50b and 50c extend away from the bait fish. The barbs 80, 90 secure the shanks 60, 70 to the bait fish to prevent rotation of the body 20 relative to the bait fish. The barbs 60, 70 may be retractable to ease removal of the shanks 60, 70 from the bait fish. The barbs 60, 70 may have sharp leading edge to pierce the skin of the bait fish. The barbs 60, 70 may have converse portions to secure the shanks 60,70 in the skin of the bait fish.

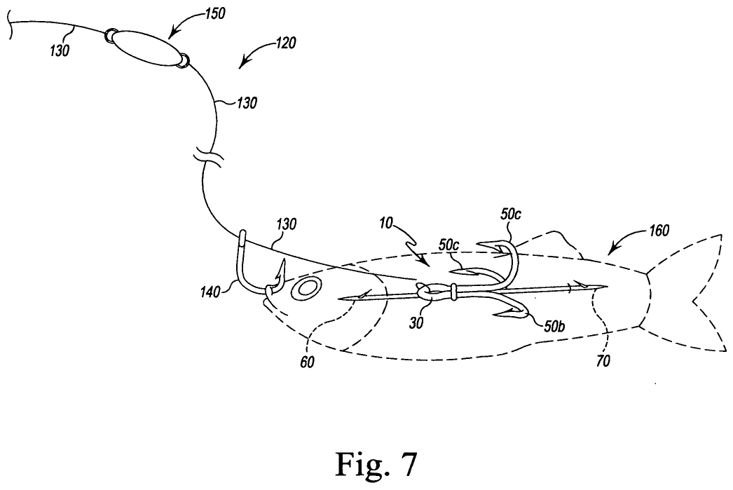

FIG. 7 illustrates hook 10 and rig 120 secured to a bait fish 160. The line 130 extends from the weight 10 to the eyelet 30. The mouth-hook 140 is secured in the bait fish 160 mouth. The shanks 60, 70 are inserted into the skin of the bait fish so that the hooks 50, 50b, 50c extend away from the bait fish. The use of two shanks 60, 70 secures the hook 10 to the bait fish and prevents rotation or release of the body 20 from the bait fish 160. The use of two shanks 60, 70 reduces potential damage or injury to the bait fish 160 and permits reuse of the bait fish 160. The use of two shanks 60, 10 better secures the hook 10 to the bait fish 160 to reduce the likelihood of losing the game fish.

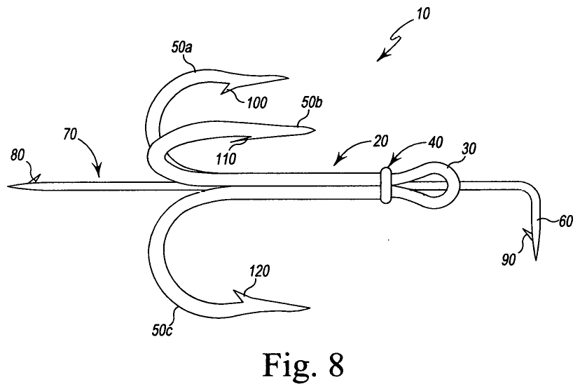

FIG. 8 shows another embodiment of the hook 10. Shank 60 extends longitudinally from the body 20 along axis A for a desired distance and then shank 60 is curved up to about 90 degrees relative to axis A. One skilled in the art will appreciate that in this embodiment the curve of the shank 60 can be at any angle from the axis A ranging from 0 degrees to almost 180 degrees without departing from the scope of the invention. None, one or both shanks 60, 70 can be straight or non-linear.

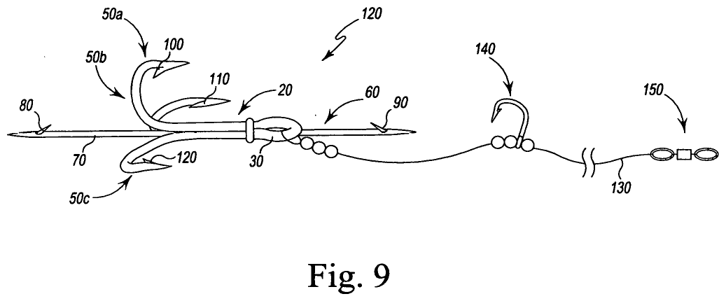

FIG. 9 shows another embodiment of the hook 10 with a rig 120 attached. The rig 120 comprises a fishing line 130 secured to eyelet 30. A mouth-hook 140 is movably secured to the line 130 to allow the mouth-hook 140 to be inserted into the mouth of the bait fish 160 regardless of the size of the bait fish 160. A weight 150 is secured to the line 130 so that the mouth-hook 140 can slide between the eyelet 30 and the weight 150. The shanks 60, 70 are inserted into the bait fish 160 so that the bottom side 20a is adjacent the bait fish and the hooks 50a, 50b and 50c extend away from the bait fish 160. The barbs 80, 90 secure the shanks 60, 70 to the halt fish to prevent rotation of the body 20 relative to the bait fish 160. The barbs 60, 70 may be retractable to ease ret oval of the shanks 60, 70 from the bait fish 160. The barbs 60, 70 may have sharp leading edges to pierce the skin of the bait fish 160. The barbs 60, 70 may have converse portions to secure the shanks 60,70 in the skin of the bait fish 160.

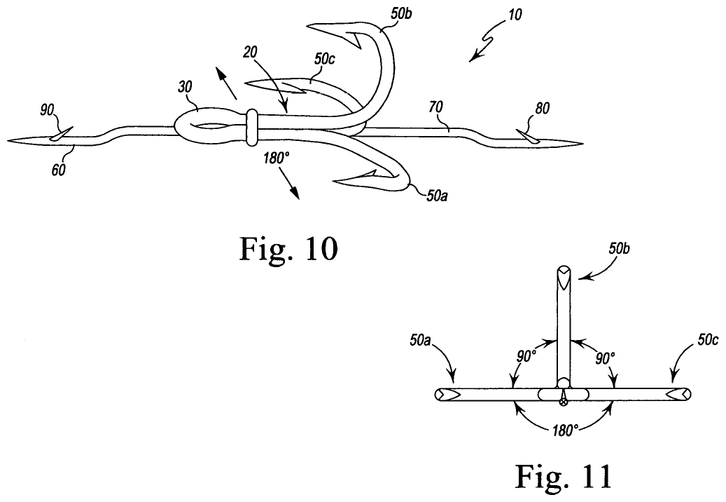

FIG. 10 shows the hook 10 with the hooks 50a, 50b, 50c extending from the body 20 so that an arc of about 180 degrees exists around the bottom side 21a with hook 50b extending from the top side 20b creating angles of about 90 degrees with hooks 50a and 50c. FIG. 11 shows the hook 10 from an end view with the hooks 50a, 50b, 50c positioned in a preferred position around the body 20.

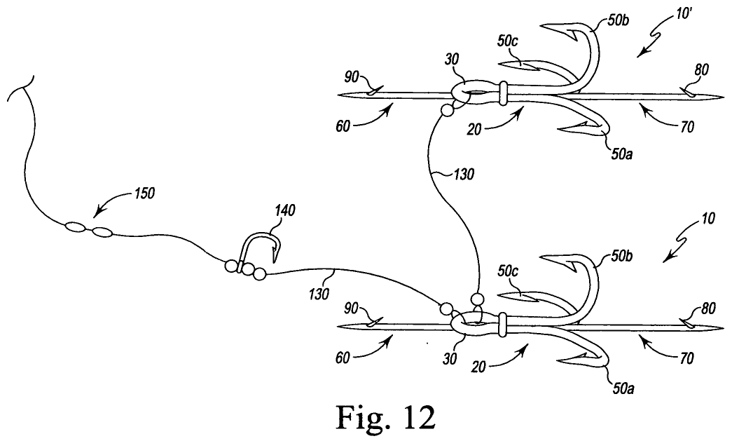

FIG. 12 shows another embodiment comprising two hooks 10, 10′. The hooks 10, 10′ can have substantially the same components or can vary as described above. In this embodiment, hooks 10 and 10′ are affixed to either side of the bait fish 160 as described above,

Other variations, whether in the number, angle, size or position of the hooks 50 and shanks 60, 70 fall within the scope of the invention. The hook 10 can be made of any material known in the art of fishing hooks.

The embodiments herein described are illustrative of the principles the present invention. Various modifications may be made by those skilled in the art without departing from the spirit or scope from the claims which follow.

1) A fish hook for live bait, comprising:
a. a body extending in a plane and defining a longitudinal axis, a first end, a second end, a top side and a bottom side;
b. a plurality of hook portions extending from the body;
c. wherein the body comprises an eyelet for attaching a fishing line;
d. at least two shanks for anchoring the fish hook to the bait, one of the shanks extending from the first end at least partially along the longitudinal axis and the other shank extending from the second end at least partially along the longitudinal axis, and
e. the at least two shanks each having at least one barb extending from the shank for anchoring the fish hook to the live bait, wherein the barbs are adapted substantially to prevent rotation of the body about the longitudinal axis relative to the live bait.

2) The fish hook of claim 1, wherein the barbs comprise a cutting edge so as to be securable to the live bait without affecting the livelihood of said live bait.

3) The fish hook of claim 1, wherein the barbs are retractable.

4) The fish hook of claim 1, wherein the shank extending from the first end is non-linear.

5) The fish hook of claim 1, wherein the shank extending from the first end is generally linear.

6) The fish hook of claim 1, wherein the shank extending from the second end is non-linear.

7) The fish hook of claim 1, wherein the shank extending from the second end is generally linear.

8) The fish hook of claim 1, wherein the at least two shanks are adapted to release from the live bait upon receiving a force without affecting the livelihood of the bait.

9) The fish hook of claim 1, wherein the plurality of hook portions hooks are spaced apart at substantially right angles from each other about 90 degrees radially from the longitudinal axis.

10) The fish hook of claim 1 wherein the eyelet is positioned generally at the first end.

11) The fish hook of claim 1 wherein the eyelet is positioned generally at the second end.

12) The fish hook of claim 1 wherein the eyelet is positioned on the body between the first end and the second end.

13) A fish hook for live bait, comprising:
a. a main body extending in a plane and defining a longitudinal axis, a first end, a second end, a top side and a bottom side;
b. wherein the first end of the body comprises an eyelet for attaching a fishing line;
c. a plurality of hook portions extending from the body;
d. at least two shanks for anchoring the fish hook to the bait, one of the shanks extending from the first end along the longitudinal axis and the other shank extending from the second end along the longitudinal axis;
e. the at least two shanks each having at least one barb extending from the shank for anchoring the fish hook to the live bait, wherein the barbs are adapted substantially to prevent rotation of the body about the longitudinal axis relative to the live bait; and
f. a rig comprising a weight attached to the fishing line, a mouth-hook secured to the fishing line for insertion into a mouth of the live bait, wherein the fishing line is secured to the evelet.

14) The fish hook of claim 13, wherein the barbs comprise a cutting edge so as to be releasably securable to the live bait without affecting the livelihood of said live bait.

15) The fish hook of claim 13, wherein the barbs are retractable.

16) The fish hook of claim 13, wherein the shank extending from the first end is non-linear.

17) The fish hook of claim 13, wherein the shank extending from the first end is generally linear.

18) The fish hook of claim 13, wherein the shank extending from the second end is non-linear.

19) The fish hook of claim 13, wherein the shank extending from the second end is generally linear.
